(19) United States
(12) Patent Application Publication
(10) Pub. No.: US 2016/0210000 A1
(43) Pub. Date: Jul. 21, 2016

(54) METHOD AND APPARATUS FOR CONFIRMING A TRANSACTION ON A MOBILE DEVICE

(71) Applicant: Bank of America Corporation, Charlotte, NC (US)

(72) Inventors: Daniel M. Whipple, Harrisburg, NC (US); Darin G. Mallory, Plainfield, IL (US); Savit A. Pirl, Boling Brook, IL (US); Christopher Hope, Tonbridge Kent (GB); Mary R. Rosendahl, Wilmette, IL (US); Milton Santiago, JR., Chicago, IL (US)

(21) Appl. No.: 15/083,579

(22) Filed: Mar. 29, 2016

Related U.S. Application Data
(63) Continuation of application No. 13/661,083, filed on Oct. 26, 2012.

(51) Int. Cl. G06F 3/0482; G06F 3/0488; G06Q 20/40; G06Q 20/42; G06Q 20/10; G06Q 20/30

(52) U.S. Cl. CPC G06F 3/0482; G06Q 20/102; G06Q 20/30; G06Q 20/401; G06Q 20/42; G06F 3/0488

(57) ABSTRACT

A method and apparatus that improves the display treasury management functionality for a cash positioning and reporting system is provided. Several portions of the payment process may be improved. The approval process may be streamlined by providing supplemental contact information at each stage of the approval process. Confirmation of payments via wire transfers may be sent to a payee. Transactions may be approved or rejected from increasingly detailed descriptions of the transactions. Transactions that have been successfully completed may be confirmed. Incomplete or unsuccessful transactions may be reconciled for further action by a user. Each transaction list by sorted as needed.

### CROSS-REFERENCE TO RELATED APPLICATION

This application is a continuation of prior U.S. patent application Ser. No. 13/661,083, filed on Oct. 26, 2012, which is hereby incorporated by reference herein in its entirety.

### FIELD OF TECHNOLOGY

Aspects of the disclosure relate to a cash positioning and reporting system displayed on a mobile device. Cash positioning typically refers to tracking daily cash positions for an entity and/or management of treasury functions.

### BACKGROUND

For the purpose of this application, treasury functions may include receiving payments, facilitating payments, stopping checks, etc. Facilitation of payments may include facilitating wire transfers or providing access to lines of credit. It should be noted that payments may be in different currencies and may require currency conversion.

Wire transfer or credit transfer is a method of electronic funds transfer from one person or institution (entity) to another. A wire transfer can be made from one bank account to another bank account or through a transfer of cash at a cash office.

Central bank wire transfer systems, such as the Federal Reserve's FedWire system in the United States typically operate as Real Time Gross Settlement (“RTGS”) systems. RTGS systems provide the quickest availability of funds because they provide immediate “real-time” and final “irrevocable” settlement by posting the gross (complete) entry against electronic accounts of a wire transfer system coordinator.

A bank wire transfer may be effected as follows: The entity wishing to do a transfer approaches a bank and gives the bank the order to transfer a certain amount of money. An international bank account number (“IBAN”) and/or other codes are given as well so the bank knows where the money needs to be sent. The sending bank transmits a message, via a secure system (such as SWIFT or Fedwire), to the receiving bank. The message provides payment instructions. The message also includes settlement instructions. The actual transfer may not be instantaneous: funds may take several hours or even days to move from the sender's account to the receiver's account. Either the banks involved holds a reciprocal account with each other, or the payment must be sent to a bank with such an appropriate reciprocal account, a correspondent bank, for further transfer to the ultimate recipient.

The payment process may involve multiple levels of approval. Approval may be a manual or a partially manual process. Confirmation of payment may require multiple phone calls, emails, text messages or any other suitable means of communication. Tracking and display of wire transfer payments in a general ledger system may be difficult.

In particular a networked mobile device such as a smartphone, Iphone™, Ipad™, Antroid™ device, Kindle™ or any other suitable device may be used to effect or approve one or more steps of the payment process. Mobile devices typically have limited screen sizes and touch screen inputs. Therefore, a system that facilitates completing, displaying and tracking of one or more of these steps on a mobile device would be desirable.

### SUMMARY

An enhanced treasury management functionality for a cash positioning and reporting system is provided. Several stages of the payment process may be implemented. The approval process may be streamlined by displaying supplemental contact and reference information at each stage of the approval process. The display of information may be sorted and displayed in a manner that provides essential details for one or more payment stages. Additionally, confirmation of a payment stages or steps is provided even if the mobile device suffers a failure or is temporarily disconnected from the network.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 illustrates a schematic diagram of a general-purpose digital computing environment in which one or more aspects of the present invention may be implemented;

FIG. 2 shows a schematic diagram of an exemplary payment system according to the invention;

FIG. 3A shows a schematic diagram of a first embodiment of the display windows which access the payment approval process according to the invention;

FIG. 3B shows a schematic diagram of a first embodiment of the display windows which access the payment approval process according to the invention;

FIG. 3C shows a schematic diagram of a first embodiment of the display windows which access the payment approval process according to the invention;

FIG. 4A shows a schematic diagram of another embodiment of the display windows which access the payment approval process according to the invention;

FIG. 4B shows a portion of a schematic diagram of another embodiment of the display windows which access the payment approval process according to the invention;

FIG. 4C shows a portion of a schematic diagram of another embodiment of the display windows which access the payment approval process according to the invention;

FIG. 4D shows a portion of a schematic diagram of another embodiment of the display windows which access the payment approval process according to the invention;

FIG. 5 shows a schematic diagram of an embodiment of a portion of the display windows which access the payment approval process according to the invention;

FIG. 6 shows a schematic diagram of an embodiment of a portion of the display windows which access the payment approval process according to the invention;

FIG. 7A shows a portion of a schematic diagram of an embodiment of a portion of the display windows which access the payment approval process according to the invention;

FIG. 7B shows a portion of a schematic diagram of an embodiment of a portion of the display windows which access the payment approval process according to the invention;

FIG. 8 shows an exemplary request for approval sent via Small Message Service (SMS) according to the invention; and

FIG. 9 shows a schematic diagram of an embodiment of a portion of the display windows which access the payment approval process via email according to the invention.

### DETAILED DESCRIPTION OF THE DISCLOSURE

An enhanced treasury management functionality for a cash positioning and reporting system is provided. Aspects of the approval process may be streamlined by displaying selectable transactions at each stage of the approval process in one more display windows. A display window may show a portion of the approval process, list(s) of transactions to be approved, list(s) of transactions that are approved/rejected and list(s) of transactions that are confirmed and/or any combination of two or more lists. Transactions may be payments, transfers of funds or any other suitable financial item.

Transaction information may include contact information for approvers or payees. The approval process may be the approval of an invoice. At each stage of the approval process a list of previous approvers may be provided, showing a “chain of approver-ship”. Typically, the last approvers of the chain are more senior. The more senior approvers may wish to change some portion of the invoice or confirm details with a particular junior approver. The chain of approver-ship facilitates changes and confirmations.

In certain embodiments of the invention, some or all of screens may be unique to a designated country. As such, the fields in such screens may correspond to the data requirements of the country. In such embodiments, repetitive tasks such as determining which data is required for which country, may be eliminated because the system and/or method according to the invention provides country-specific screens; preferably with country-specific formatting requirements.

Selection of an icon, transaction or any item shown on a display window may be performed by any suitable means including clicking, double clicking or the use of “gestures”. Selection may highlight the item or cause another display window to appear and/or to replace the currently shown display window with a different display window. Selection of an item can simply highlight that item or cause the display of a further menu in reference to the selected item. In some cases, re-selection (a double click) will cause another display window to appear or to replace the currently shown display window with a different display window. The appearance of a new display window may be described as “opening” the display window. However, for the purposes of this application, the term “opening” refers to the action that causes another display window to appear or the for the current display window to be reformatted.

When transactions are made via a wire transfer, a reference number may be provided to the payee so that payment can be confirmed and tracked. The reference number may be accompanied by additional information to facilitate tracking of the payment by the payee. Typically, a wire transfer cannot be reversed; therefore the reference number may be considered proof of payment. If the payment is used to purchase goods or services then these items may be released upon receipt of the reference number.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, flash devices and/or any combination thereof. In addition, various signals representing data or events as described herein may be transferred between a source and a destination in the form of electromagnetic waves traveling through signal-conducting media such as metal wires, optical fibers, and/or wireless transmission media—e.g. air and/or space.

Data may move between various entities in any of the embodiments of the invention via electronic transmission or manual means. Electronic transmission may utilize email, SMS or any other suitable method. Manual exchange may utilize floppy disks, USB drives, CDs, DVDs or any other suitable mechanism.

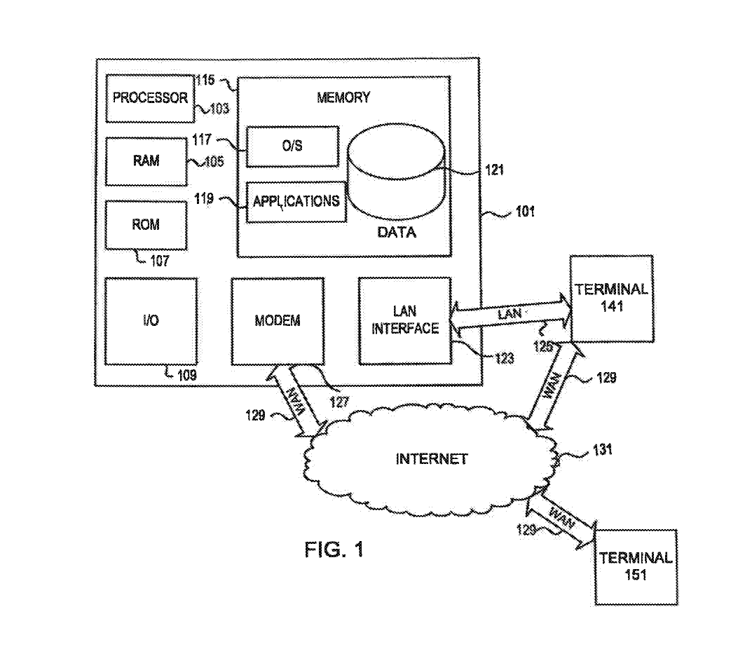

FIG. 1 is a block diagram that illustrates a generic computing device 101 that may be used according to an illustrative embodiment of the invention. Computing device 101 may be server that provides coordinating services for a number of mobile computing devices. In one alternative embodiment computing device 101 is a mobile device used to implement the invention. The mobile computing device may be termed user devices.

Computing device 101 may have a processor 103 for controlling overall operation of the server and its associated components, including RAM 105, ROM 107, input/output module 109, and memory 115. Computing device 101 may include one or more receiver modules, server modules and processors that may be configured to transmit and receive payments, wire transfers, payments via checks, debit cards, credit cards, lines of credit or any suitable credit instrument. Likewise, computing device 101 may be configured to transmit and/or receive information and to provide from/to an Enterprise Resource Planner (“ERP”) or any other suitable system. Further, computing device 101 may provide confirmation to one or more payees and facilitate payment approval processing and perform any other suitable tasks related to treasury operation within a cash positioning and reporting system. Additionally computing device 101 may provide confirmation to mobile devices or terminals 141, 151 which implement the invention.

Input/output (“I/O”) module 109 may include a microphone, keypad, touch screen, and/or stylus through which a user of computing device 101 may provide input, and may also include one or more of a speakers for providing audio output and a video display device for providing textual, audiovisual and/or graphical output. The touch screen may also serve as a video display device. The touch screen may respond to gestures—e.g. a double tap may open an item and a pinching motion may shrink an item. The touch screen in combination with the video display may be referred to as the “display” of the device.

Software may be stored within memory 115 to provide instructions to processor 103 for enabling computing device 101 to perform various functions. For example, memory 115 may store software used by computing device 101, such as an operating system 117, application programs 119, and an associated database 121. Alternatively, some or all of computing device 101 computer executable instructions may be embodied in hardware or firmware (not shown). As described in detail below, database 121 may provide storage for customer information, invoices, approvals, various types of confirmations and any other suitable information.

Computing device 101 may operate in a networked environment supporting connections to one or more remote computers, such as mobile devices 141 and 151. Mobile devices 141 and 151 may be personal computers or servers that include many or all of the elements described above relative to computing device 101.

The network connections depicted in FIG. 1 include a local area network (LAN) 125 and a wide area network (WAN) 129, but may also include other networks. When used in a LAN networking environment, computing device 101 is connected to LAN 125 through a network interface or adapter 123. When used in a WAN networking environment, computing device 101 may include a modem 127 or other means for establishing communications over WAN 129 and/or Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by computing device 101, may include computer executable instructions for invoking user functionality related to communication, such as email, short message service (SMS), and voice input and speech recognition applications.

Computing device 101 and/or mobile devices 141, 151 may also be mobile terminals including various other components, such as a battery, speaker, and antennas (not shown).

Computing device 101, terminal 151 and/or terminal 141 may be portable devices such as a laptop, cell phone, Blackberry™, smartphone, iPad™, iPhone™, Kindle™ or any other suitable device for storing, transmitting and/or transporting relevant information.

Any information described above in connection with database 121, and any other suitable information, may be stored in memory 115.

One or more of applications 119 may include one or more algorithms that may be used to perform one or more of the following: treasury operations, wire transfers and any other suitable tasks related to treasury operations.

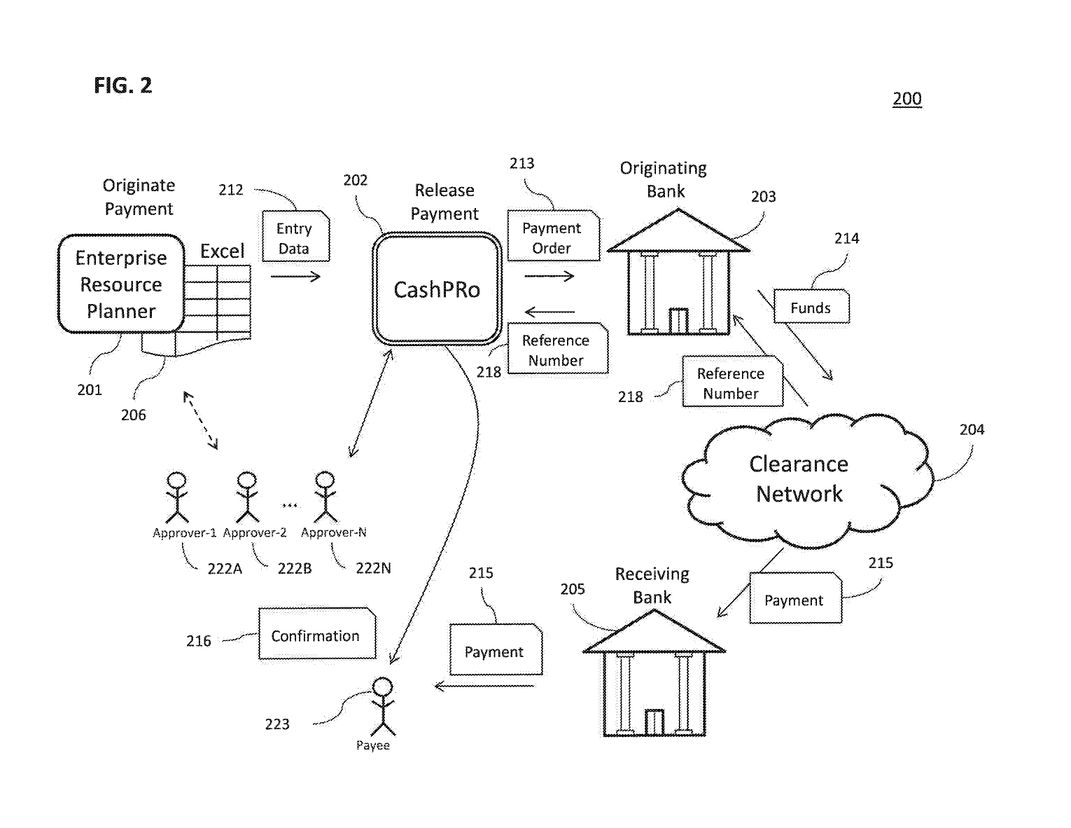

FIG. 2 shows an exemplary schematic diagram of a payment system 200 according to the invention. A similar schematic, with greater detail, is explained in patent application Ser. No. 13/361,024, 13/569,055 and 13/361,044 all of which are hereby incorporated by reference herein in their respective entireties. Payment may originate in an ERP system 201, Excel workbook 206, or other similar automated, semi-automated, or manual process. The ERP system 201 may be a Systems Analysis and Program development (“SAP”) ERP, an Oracle™ system or any other suitable system. The ERP system 201 may generate entry data 212 for a cash positioning and reporting system (“CashPRo”) 202. CashPRo™ system 202 may provide one or more treasury functions. In the alternative, treasury functionality may be provided by a standalone system, distinct from the CashPRo™ system 202.

Entry data 212 may include an invoice or several invoices. Entry data 212 may use any suitable format including standard formats. Entry data 212 may be sent from the ERP system 201 to CashPRo™ system 202 electronically or manually. Each field of the data may be verified for correctness as is described in U.S. patent publication 2009-0319429 and is hereby incorporated by reference.

Prior to the transfer of entry data 212 to the CashPRo™ system 202 an approval process may be required. The approval process may start in ERP system 201 and continue in CashPRo™ system 202 or it may be completely contained within CashPRo™ system 202. There may be separate approval processes for each of ERP system 201 and CashPRo™ system 202. Typically the CashPRo™ system 202 coordinates the entire approval process.

The CashPRo™ system 202 may facilitate an approval process that involves one or more approvers. An exemplary chain of approvers are shown as Approver-1 222A, Approver-2 222B through other approvers until the final approver, Approver-N 222N. The configuration of approval depends on customer preferences. No approval at all is contemplated and included within the scope of the invention.

After a successful conclusion to the approval process, CashPRo™ system 202 may produce a payment order 213, which may be sent to an originating bank 203. Payment order 213 may include a transaction number. Payment order 213 may be delivered by electronic, manual or any other suitable means.

Originating bank 203 may deliver funds 214 to a clearance network 204. Clearance network 204 may be a wire transfer clearance facility—e.g., the Federal Reserve Bank of the United States. As described above, delivery of funds 214 via a wire transfer to a clearance network 204 cannot be reversed. Delivery of funds may be by electronic, manual or any other suitable means.

Clearance network 204 may return a reference number 218 to originating bank 203. Reference number 218 may be accompanied by supplemental data and a matching transaction number. Originating bank 203 may return reference number 218 and any supplemental data to CashPRo™ system 202. Delivery of reference number 218 by clearance network 204 and/or originating bank 203 may be by electronic, manual or any other suitable means. Reference number 218 may be a clearance reference number as is provided by the Federal Reserve Bank of the United States or any equivalent reference number.

CashPRo™ system 202 may provide confirmation 216 to payee 223. Confirmation 216 may include reference number 218, invoice information and/or any other suitable information. Confirmation 216 may be delivered by electronic, manual or any other suitable means. In some cases a reference number 218 may not be provided. In some cases reference number 218 may be provided but would not be included in confirmation 216.

Clearance network 204 may provide payment 215 to receiving bank 205. Receiving bank 205 may provide payment 215 to payee 223. All payments may be transferred by electronic, manual or any other suitable means.

Although a single ERP 201, CashPRo™ system 202, originating bank 203, clearance network 204, receiving bank 205 and payee 223 are shown, more than one of any of the aforementioned items are contemplated and are included within the scope of the invention. Likewise, multiple entry data sets, payments orders, funds, reference numbers, confirmations, and invoices are contemplated and are included within the scope of the invention. Further, multiple items may be included in a single item—e.g., multiple invoices may be included in a single entry data 212.

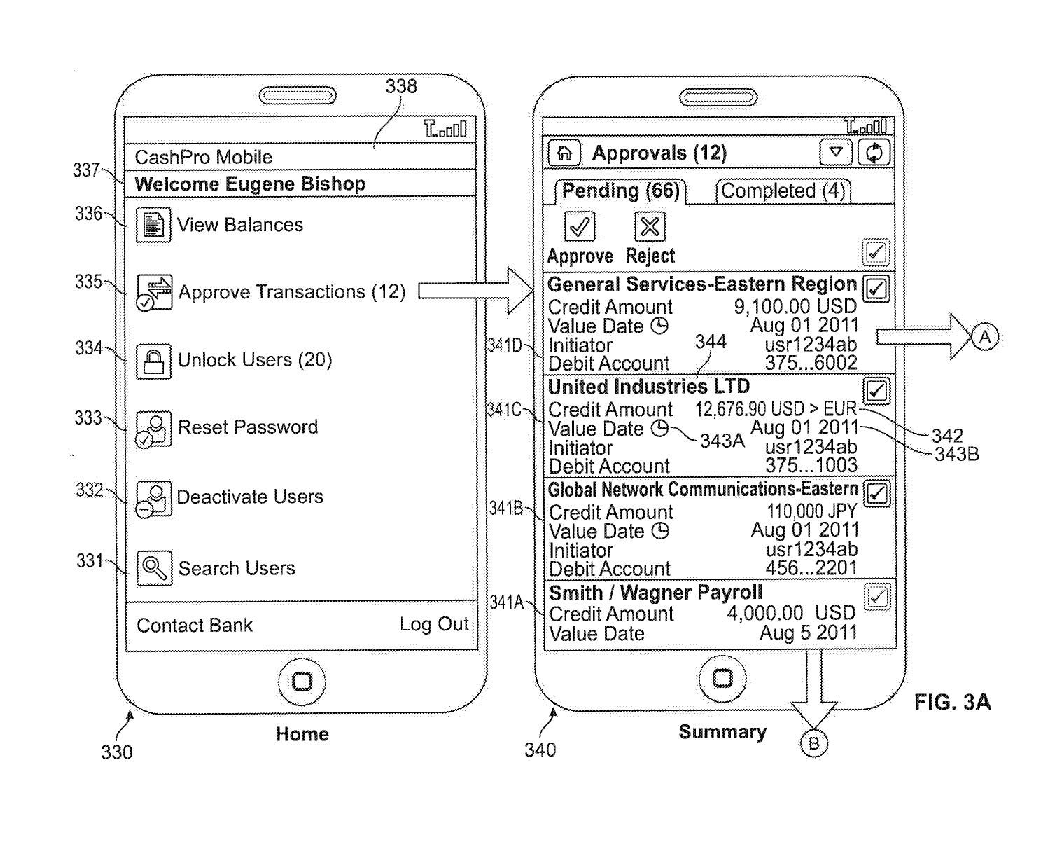

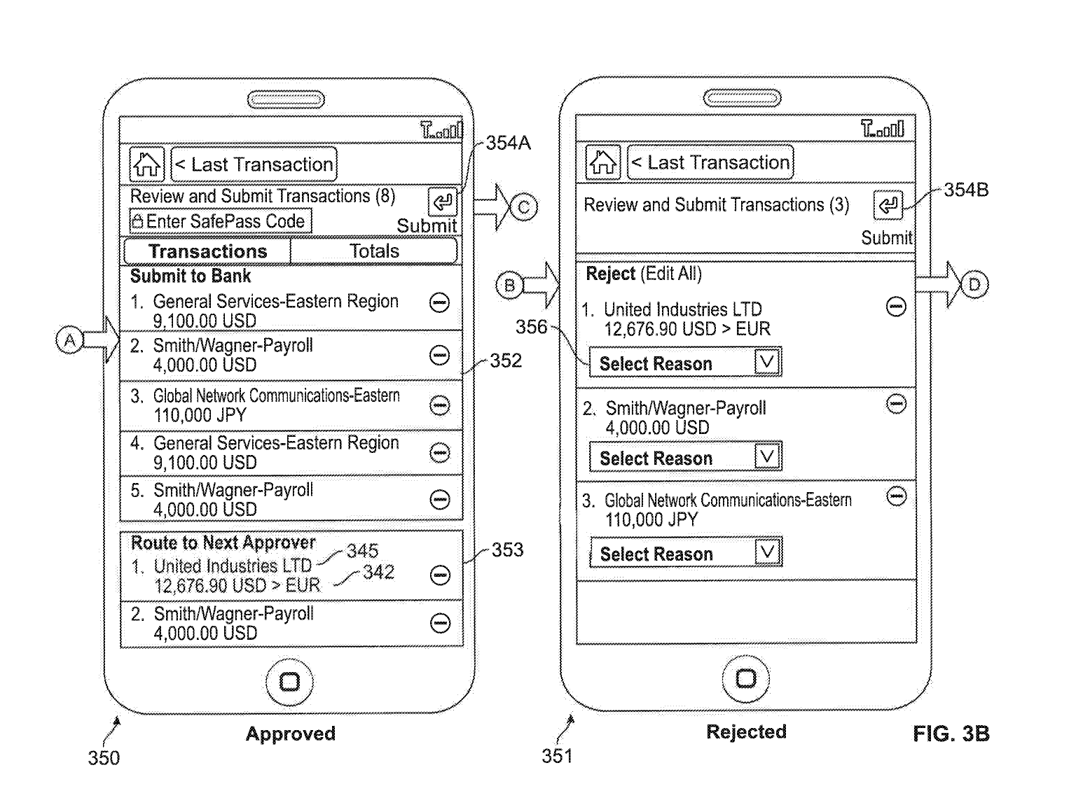

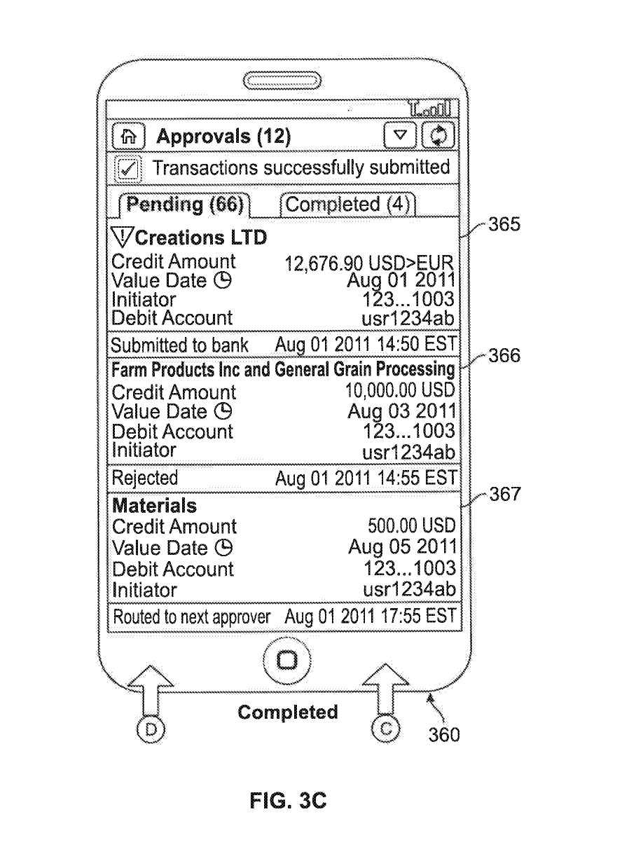

FIG. 3A-3C show an embodiment of the display windows which access the payment approval process according to the invention. For this embodiment, and all other embodiments described in the remainder of the description, the display windows may be shown on mobile device such as mobile terminals 141, 151 or on a server. Although reference is made to elements of FIG. 2, other ERP, CashPRo™ systems, banks and clearance networks, reference numbers, etc., may be used in this embodiment or any suitable variation of this embodiment. Although each display window is shown as the only displayed item, each display window of the invention may occupy a portion or the entirety of the available display area of the device. In some embodiments fixed areas for the display area may display advertisements, user information—e.g., the users name and/or operating system elements such as a battery life icon or any other suitable items.

In this description a list refers to an entire list of zero items, one item or many items. However, it is understood that typically only a portion of the list is displayed on the display window. Although an exemplary set of entries are shown in the figures for clarity, various devices may alter the manner in which each display window is shown. Various factors such as screen size, pixel count, font size, etc., may limit the number of entries and/or sections displayed. In each case entries, portions of list or sections that do not fit in the available display area may preferably be accessed by scrolling.

Display window 330 shows a “home” display window menu containing common items. Display window 330 shows a search users item 331, a deactivate users item 332, a reset password item 333, an unlock users item 334, an approve transaction item 335 and a view balances item 336. The top of the display window 330 may display the users name 337 and the application 338—e.g., CashPRo™. Other items or applications may also be shown on the “home” display window or may be shown by scrolling the menu. Opening the approve transaction item 335 displays the summary display window 340.

Summary display window 340 shows a partial list of transactions 341A-341D that require approval as part of approval process described above with reference to FIG. 2. The user of the approve transaction application may be any approver from FIG. 2—e.g. Approver-1 222A. Exemplary entry 341C may show a company name 344, a transaction amount 342, a value date icon 343A and a value date 343B, as well as other suitable information. Each transaction 341A-341D may show similar information in a typical display 340. Each transaction may preferably represent a payment.

Value date icon 343A may be color coded to indicate the urgency of the approval. The value date represents the last acceptable date/time for a timely payment. Failure to pay on time may result in loss of faith, interest payments, penalties, etc. Typically a green icon indicates relatively little no urgency, a yellow icon indicates relatively greater urgency and a red icon indicates relatively great urgency. Urgency may also be shown by blinking the icon or any other suitable audio and/or visual indication.

Approving a transaction may place the transaction on an approved list that may be displayed on approved display window 350. Approved display window 350 is shown in FIG. 3B and may be reached by following off-page connector A. Rejecting a transaction may place the transaction on a rejected list that may be displayed on rejected display window 351. Rejected display window 351 is shown in FIG. 3B by following off-page connector B. Approved display window 350 and rejected display window 351 may be combined into a single display window. Each approval or rejection may result in the display of the approved display window 350 or the rejected display window 351.

Approved display window 350 may be divided into sections such as “submit to the bank” 352 and/or “route to next approver” 353. Each section 352, 353 may have a list with no entries, one entry or many entries. Each entry may be limited to displaying the company name 345 and transaction amount 342. In the alternative other information may be supplied in the review display window or on a different detailed display window (not shown).

Transactions in the “submit to the bank” section 352 typically represent payments approved by the final approver on the approval list—e.g. Approver-N 222N. Transactions appearing in the “route to the next approver” section 353 may represent payments approved by an intermediate approver or initial approver—e.g. Approver-1 222A or Approver-2 222B.

Rejected display window 351 may allow selection of a reason for rejection via selector 356. Exemplary reasons for rejection are insufficient funds in the account, etc. An open reason, or a fill-in rejection field, may be provided to cover cases that occur infrequently.

Approved display window 350 and/or rejected display window 351 may contain a submit icon 354A, 354B respectively. Opening submit icon 354A and/or 354B may cause completed display window 360 to appear. Completed display window 360 is shown in FIG. 3C. Completed display window 360 may be reached by following off-page connector C from the approved display window 350 or following off-page connector D from the rejected display window 351. Completed display window 360 may show a list of transactions that are confirmed as complete. Completed display window 360 may show a date/time that indicates when all of the transactions shown are confirmed as complete.

Because the connection to a mobile device maybe inconsistent or irregular, a user may approve or reject a transaction on his or her device—e.g. mobile terminal 141,151—without gaining the full effect of the desired action. In some cases only a portion of the data or none of the data necessary to complete the transaction are sent to the server 101. The data, or a portion of it, may not be sent because of software errors or because the connection to the server was severed or is error prone. At some future time the user device 141,151 may reconnect to server 101 and complete the transaction. At other times the user device 141,151 may be unable to complete the transaction. Display window 360 may show a list of confirmed transactions sent from the server. The list of confirmed transactions may be described as a checkpoint. Since this list is stored on the server, the user can be certain that these transactions are complete.

In some embodiments mobile device 141,151 may be able to reconcile the list of completed transactions with the list of attempted transaction in order to identify a list (not shown) of transactions that are in a “limbo” state—i.e., requested but not confirmed as executed. In some embodiments the device 141, 151 may be able to reset the state of transactions on the mobile device 141, 151 to the summary list, the approved list or the rejected list. In some embodiments the mobile device 141, 151 may query the server regarding the list of attempted transactions and the server 101 send reconciled lists (summary, approved, rejected) and an updated confirmed list to the user device 141, 151.

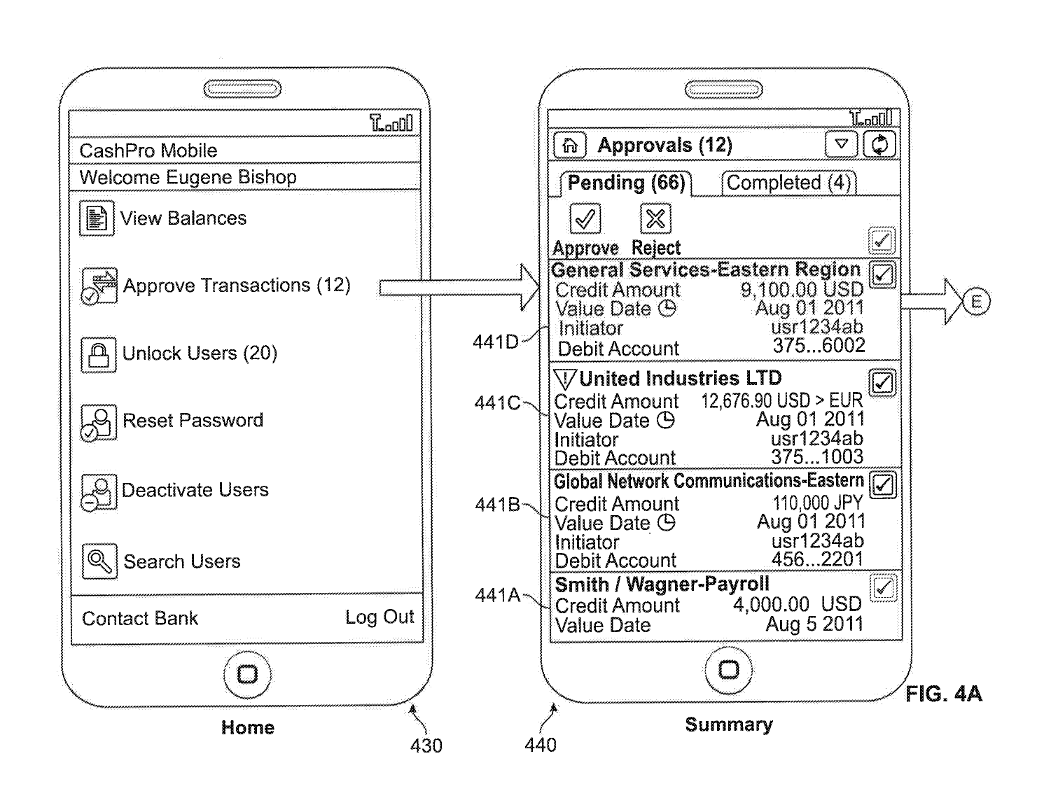

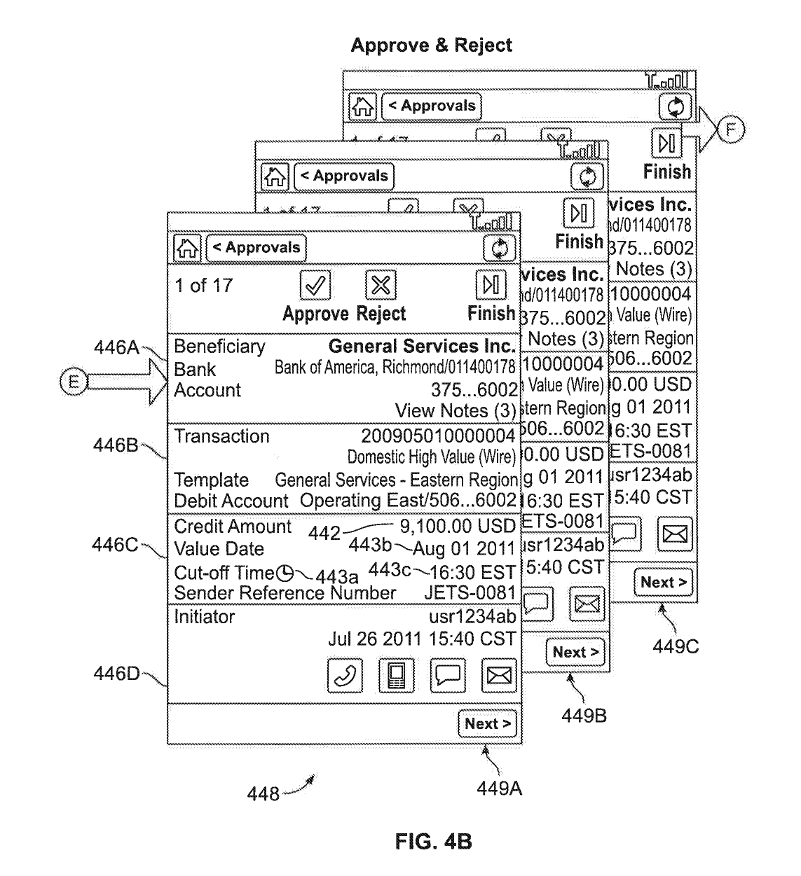

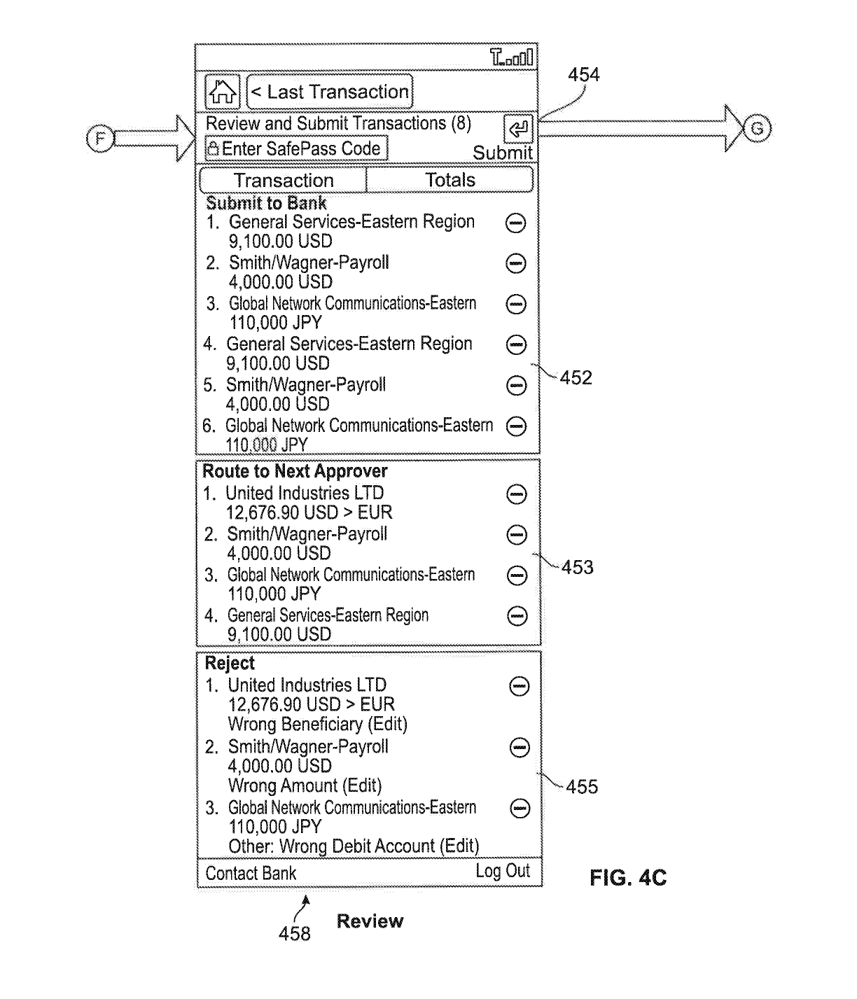

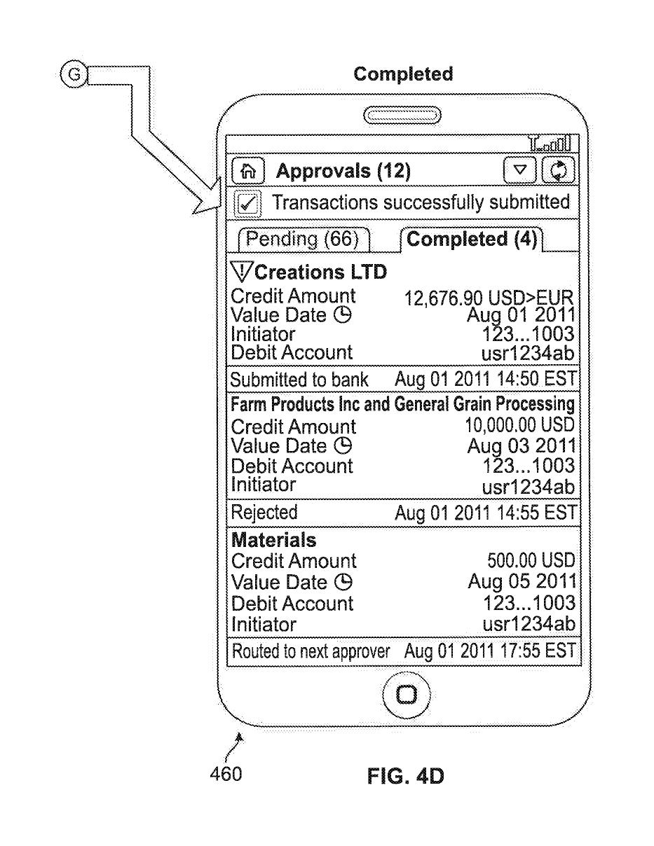

FIG. 4A-4D shows another embodiment of a system of display windows which accesses the payment approval process according to the invention. Display window 430 shows “home” display window with similar features to the “home” display window 330. Summary display window 440 shows a partial list of transactions 441A-441D that require approval as part of approval process described above with reference to FIG. 2. The user of the approve transaction application may be any approver from FIG. 2—e.g. Approver-1 222A.

Each transaction 441A-441D may have similar information in a typical display 440. Each transaction may represent a payment.

Opening a transaction of the summary display window 440 may open one more detailed descriptions of transactions. The detailed descriptions the transactions are shown in FIG. 4B and may be reached by following off-page connector E. Exemplary display window 448 shows a cascade of three overlapping detailed descriptions 449A-449C from a total of seventeen. Alternate embodiments may show only a single transaction or create a non-overlapping display of several transactions. All of the transactions may be shown or a limited number may be shown depending on user preferences and display area (screen size) limitations. Typically the transaction that was selected prior to opening would appear as the top of the cascade. In the alternative the cascade may appear in a sorted arrangement or any other suitable arrangement.

Exemplary detailed description 449A may have an identification section 446A, a logistic section 446B, a transaction section 446C and an actor section 446D. Each section may have further detail that may be shown in another display window (not shown).

Exemplary identification section 446A may show information about a payee or client such a company name, payee bank, account number and any other suitable information.

Exemplary Logistic section 446B may show a transaction number, transaction type—e.g. wire transfer, a template and a source of funds or any other suitable information.

Exemplary Transaction section 446C may show a transaction amount 442, a cut off time icon 443A, value date 443B, a value time 443C and any other suitable information. Value date icon 443A may be color coded to indicate the urgency of the approval as described above.

Exemplary actor section 446D may have the computer ID of an actor or several of the actors for the transaction. An actor may be the initiator of the transaction, the previous approver on the list of approver's, the next approver on the list of approvers or any suitable actor in the approval chain. More detailed information such as an ordered list of approvers or the contact information of any approver may be available upon opening this section. Contact information may include phone numbers, email addresses or social network contact information.

Approving a transaction may place the transaction on a review list that may be displayed in the “submit to bank” section 452 or the “route to next approver” section 453 of review display window 458. Rejecting a transaction may place the transaction on a review list that may be displayed in a rejected section 455 of review display window 458. Each approval or rejection may result in the display of the review display window 458.

Display window 458 is shown in FIG. 4C and may be reached by following off-page connector F. Each section 452, 453, 455 may have no entries, one entry or many entries. Each entry may be limited to displaying the company name and the transaction amount. In the alternative, other information may be supplied in the review display window or on a different detailed display window (not shown).

Transactions in the “submit to the bank” section 452 typically represent payments approved by the last approver are the approval list—e.g. Approver-N 222N. Transactions appearing in the “route to the next approver” section 453 represent payments approved by an intermediate approver or initial approver—e.g. Approver-1 222A or Approver-2 222B. Each rejected transaction may require a reason for rejection.

Review display window 458 may contain a submit icon 354. Selecting submit icon 454 may cause completed display window 460 to appear. Completed display window 460 is shown in FIG. 4D and may be reached by following off-page connector G. Completed display window 460 may show a list of items that are confirmed as complete. Completed display window 460 is similar to completed display window 360 described above.

Although some of the display windows of embodiment 300 may be different from some of the display windows of embodiment 400, combinations of the various display windows and features of any of them in any combination are contemplated and included within the scope of the invention.

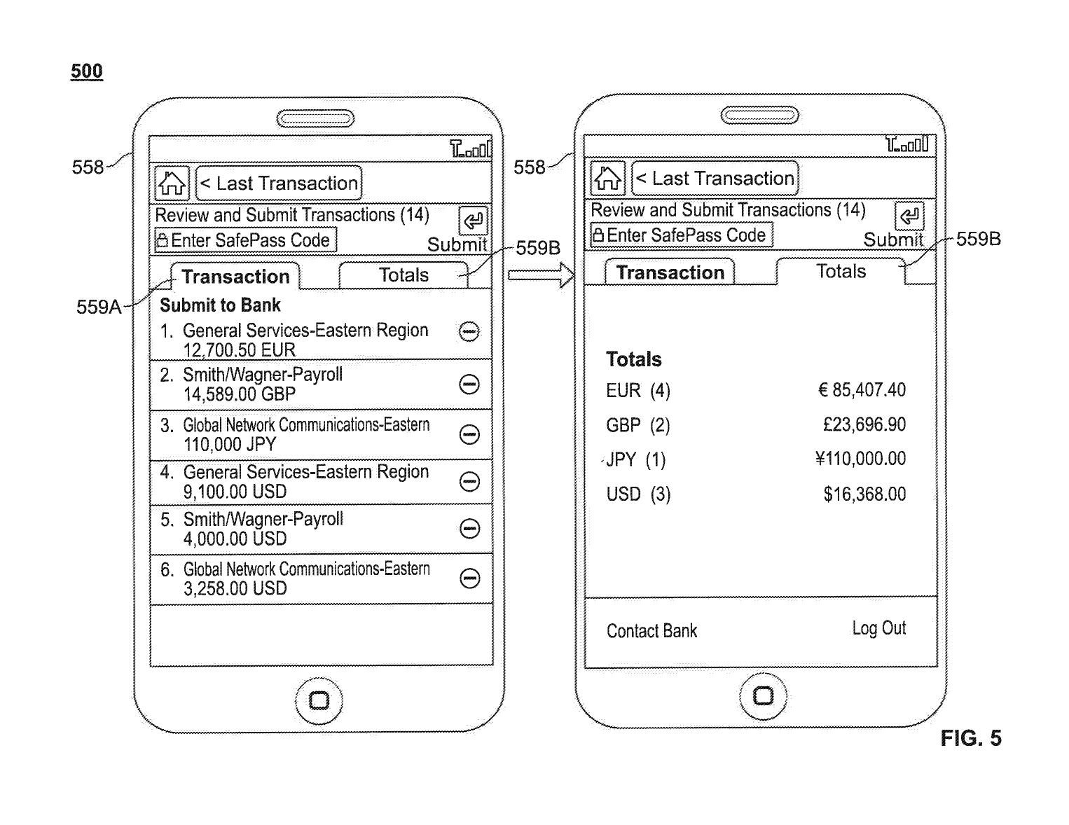

FIG. 5 is a schematic showing an embodiment 500 of some of the display windows which access the payment approval process according to the invention. Review display window 558 may be similar to review display window 458 described with reference to FIG. 4C, or it may be similar to approved display window 350 or rejected display window 351 described with reference to FIG. 3B.

Review display window 558 may contain a transaction tab 559A and a totals tab 559B. Transactions tab 559A shows a review list of transactions similar to the review list shown in FIG. 4C. Selection of the totals tab 559B shows the total currency expended for the entire review list. The totals may be shown in the currencies expended or in a common currency according to current exchange rates. In the alternative the total may show the totals by section—e.g. a total for transactions submitted to the bank, transactions that are sent to the next approver or transactions that have been rejected. Similar transaction and total tabs may appear on the summary display windows 340, 440 or the confirmation windows 360, 460.

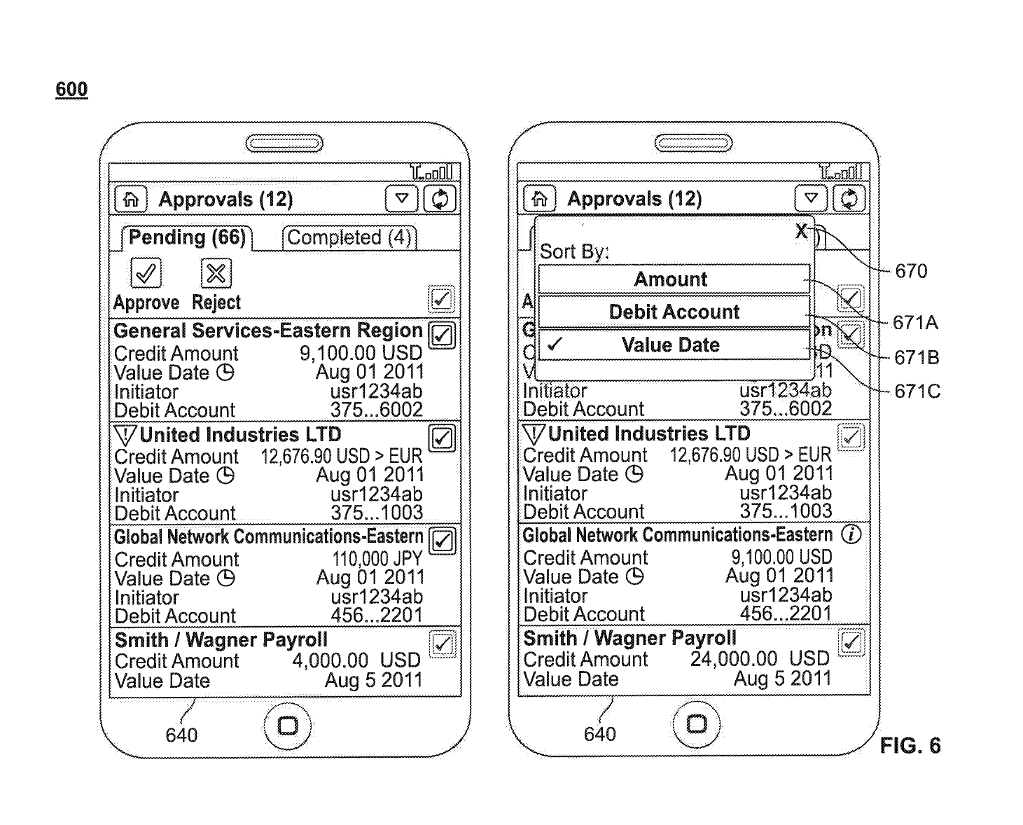

FIG. 6 is a schematic showing an embodiment 600 of a summary display window which accesses the payment approval process according to the invention. The summary display window 640 is shown in two views; one showing a list of transactions and/or one showing a sorting menu 670. Summary display window 640 may be similar to summary display window 440 described with reference to FIG. 4A, or it may be similar to summary display window 340 described with reference to FIG. 3A.

Sorting menu 670 offers the options of sorting according to amount 671A, debit account 671B or value date 671C. Other suitable sorting categories or combinations of categories are contemplated and are included within the scope of the invention.

Selection of a sorting category reorders the displayed list. The list may be sorted in ascending or descending order. The top of the list or the currently selected transaction may appear in the newly sorted display.

Although a sorting of the list displayed on list displayed by the summary display window, any other list described previously—e.g. the rejected transaction list—may be sorted with same categories already described or other suitable categories.

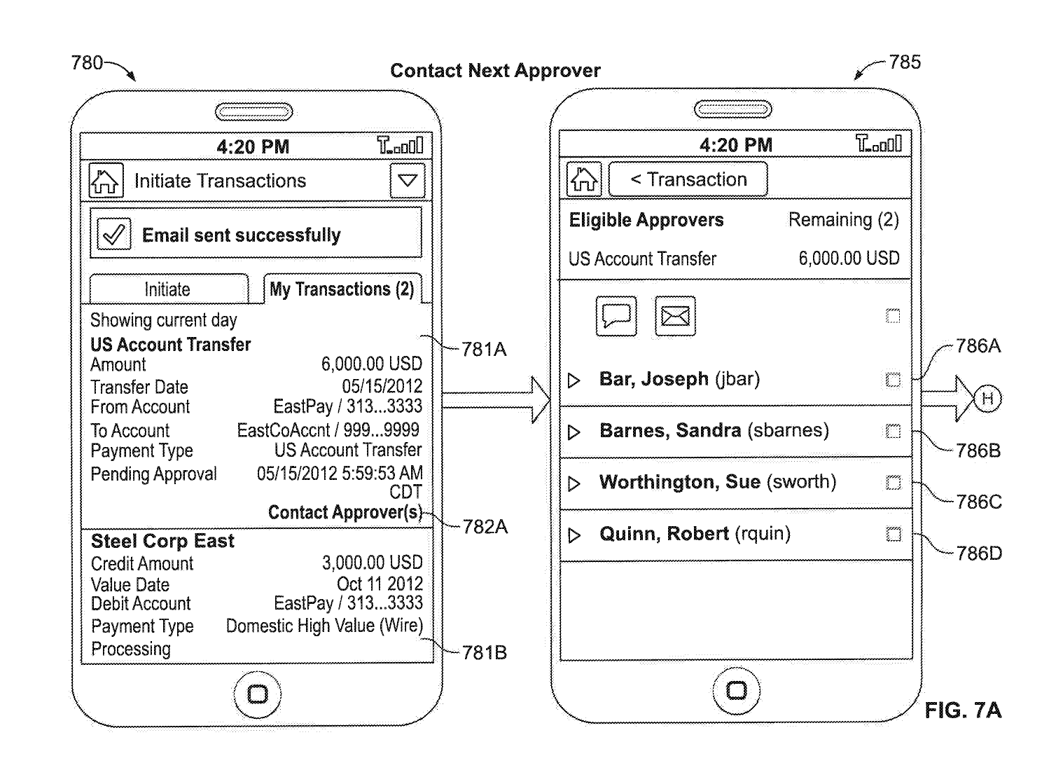

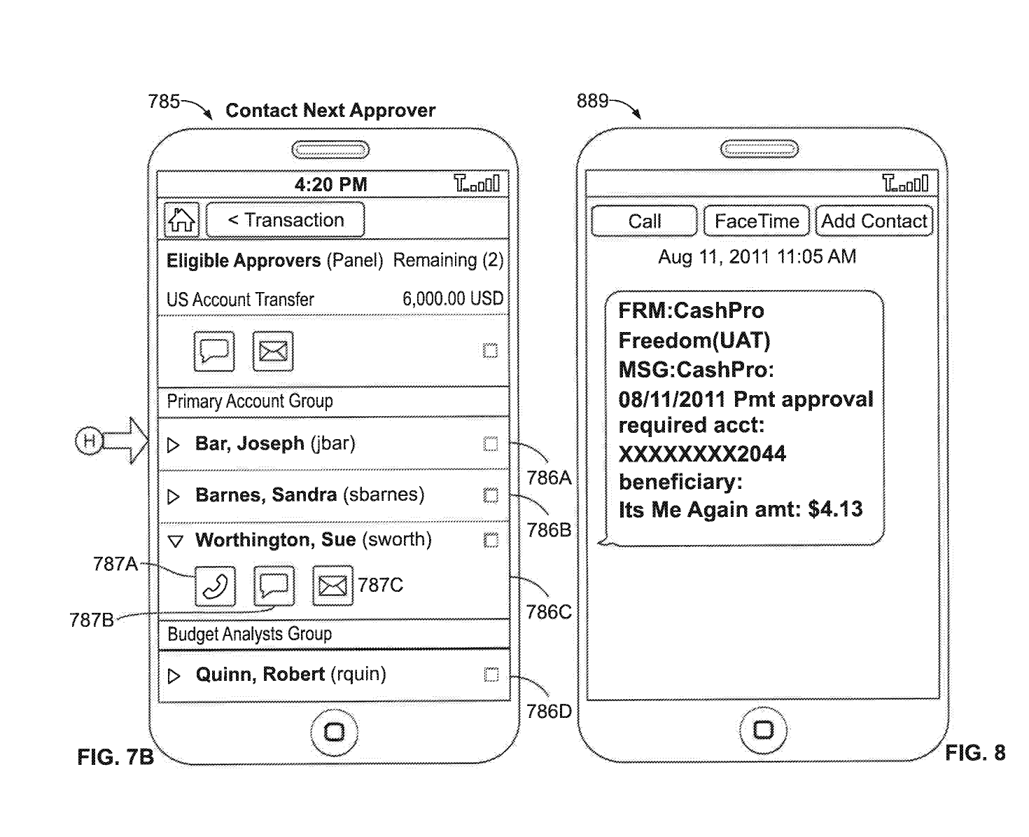

FIG. 7A-7B shows an alternate embodiment of a system of display windows which accesses the payment approval process according to the invention. Approval display window 780 may be similar to the completed display window 360 or completed display window 460. In the alternative, approval display window 780 may be similar to summary window 340 or summary window 440.

Approval display window 780 shows a partial list of transactions that require approval as part of approval process described above with reference to FIG. 2. The user of the approve transaction application may be any approver from FIG. —e.g. Approver-1 222A. Approval display window 780 may contain exemplary transactions 781A and 781B.

Opening the contact approver link 782A of transaction 781A may open approver list display window 785. Approver list display window 785 may show a partial list of approvers for transaction 781A. Approval list display window 785 may contain exemplary authorized approval contacts 786A-D. The list may show the approvers in alphabetical order, in the order of approval or any other suitable order.

Opening approver 786C may reformat approver list display window 785 to show methods of contacting approver 786C. Reformatted approver list display window may be reached by following off-page connector H to FIG. 7B.

FIG. 7B shows an exemplary view of a reformatted approver list display window showing three contact icons for approver 786C. Each icon represents a different method of contact. Exemplary contact methods are voice contact icon 787A, SMS contact icon 787B and email contact icon 787C. Each icon may contain a symbol indicating the type of contact method available. The icons may be placed side by side or in a cascade. The icons may cascade by type—e.g. there may be several voice icons indicating the availability of several voice contact numbers.

Selecting any icon 787A-C activates the selected method—e.g. selecting SMS prompts the user for entry of an SMS message. FIG. 8 show an exemplary SMS message display screen 889 received by an approver. The SMS message display screen may have an authentication button (not shown) to authenticate the approver.

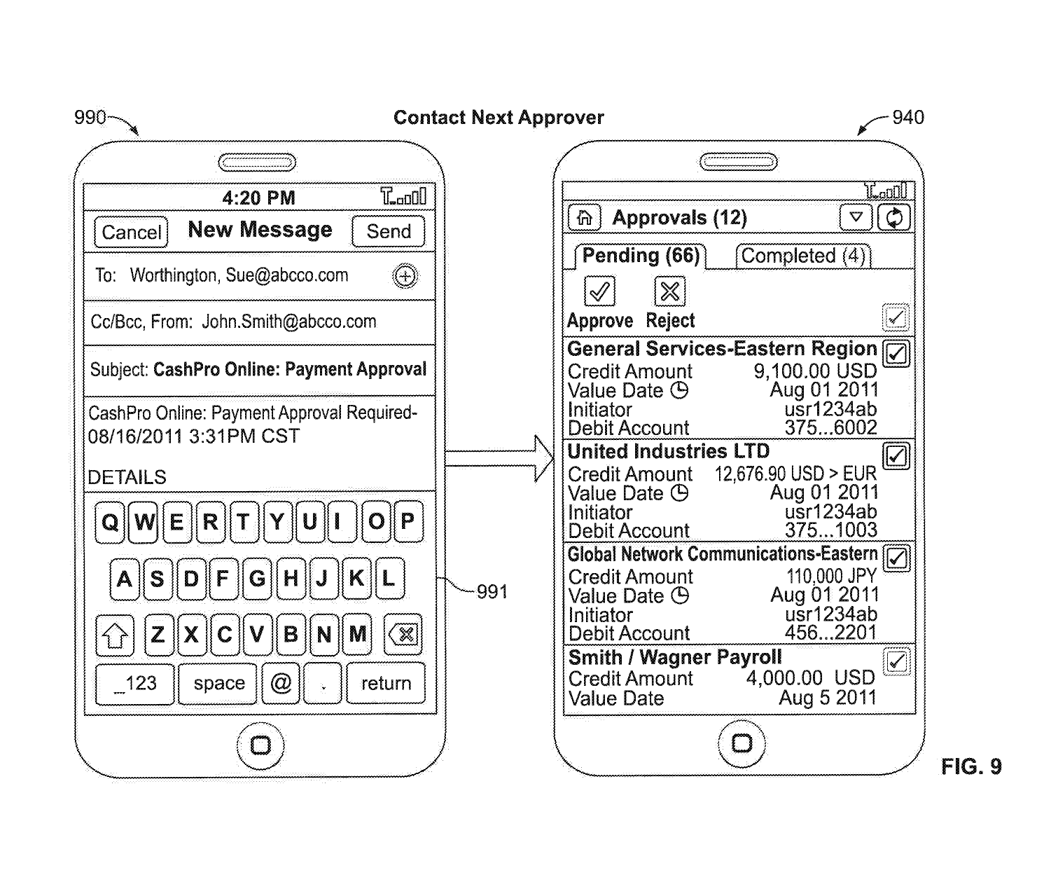

FIG. 9 shows an exemplary email display screen 990 after selection of the email icon 787C. Email display screen 990 may have a “soft” keyboard 991 to enter the email text or the device may have a hardware keyboard. Sending the email may create a transaction in the summary display screen 940 of the approvers mobile device. Summary display window 940 may be similar to summary display windows 340 or 440.

Irrespective of the contact method, the approver may be required to self-authenticate. Authentication may have the effect of submission of the transaction to the bank. In the alternative, after authentication, the approver may choose to either pass the transaction to the next approver in the chain, reject the transaction or approve submission to the bank.

Thus, apparatus and methods that enhance the display of a treasury management functionality for a cash positioning and reporting system are provided.

Persons skilled in the art will appreciate that the present invention can be practiced by other than the described embodiments, which are presented for purposes of illustration rather than of limitation, and that the present invention is limited only by the claims that follow.

What is claimed is:

1. A device for displaying a first approval of an electronic-funds-transfer (“EFT”) payment transaction for payment of a pre-existing obligation and forwarding the transaction for a second approval, the device comprising:
a display; and
a processor;
wherein:
the EFT payment transaction includes a transaction number, a transaction type, a template, a source of funds and a future time indicating an acceptable approval time for a future payment of the transaction;
the processor displays a summary display window of a touch-screen handheld device showing a list of transactions as a cascade of display windows in which only the top window is fully visible, each transaction in the cascade requiring the first approval prior to forwarding the transaction for the second approval, the second approval being received from a senior approver, the second approval facilitating a change and/or confirmation of the transaction, the second approval ensuring the accuracy of the transaction by providing, prior to execution of the transaction, a receiving-country-specific format that complies with a receiving country's country-specific formatting requirements;
the processor displays an approved display window of the touch-screen handheld device showing a list of approved transactions;
the processor displays a rejected display window showing a vertically oriented list of rejected transactions;
the processor displays a completed display window of the touch-screen handheld device showing a vertically oriented list of confirmed transactions;
the summary display window of the touch-screen handheld device shows a value date and/or timestamp that indicates a last date and/or time when each of the vertically-oriented list of transactions of the summary display window is considered timely approved; and
the processor reconciles the approved transactions and the rejected transactions with the confirmed transactions.

2. The device of claim 1, further comprising a server that compiles the list of confirmed transactions, wherein the server receives a confirmation of completion for each transaction on the list of confirmed transactions.

3. The device of claim 1, wherein the processor displays the summary display window of the touch-screen handheld device showing a sorted list of transactions.

4. The device of claim 3, wherein the list of transactions is sorted according to each transaction's future time.

5. The device of claim 4, wherein the processor displays at least one detailed description of a transaction, selected from the list of transactions, shown by the summary display window of the touch-screen handheld device.

6. One or more non-transitory computer-readable media storing computer-executable instructions which, when executed by a processor on a computer system, perform a method for displaying a first approval of an electronic-funds-transfer (“EFT”) payment transaction for payment of a pre-existing obligation on a device, and, following approval, for forwarding the transaction for a second approval, wherein the device comprises a display and a processor, the method comprising:
displaying, on a touch-screen handheld device, a summary display window, the summary display window showing a vertically-oriented list of transactions that require the first approval prior to forwarding the transaction for second approval;
displaying, on the touch-screen-handheld device, an approved display window, the approved display window showing a vertically-oriented list of approved transactions;
displaying, on the touch-screen-handheld device, a rejected display window, the rejected display window showing a vertically-oriented list of rejected transactions, the rejected-display window being displayed relatively lower than said vertically-oriented list of approved transactions;
displaying, on the touch-screen handheld device, a completed display window, the completed display window showing a list of confirmed transactions;
wherein:
the approved display window of the touch-screen handheld device shows a future time that indicates an acceptable approval time when each transaction, included in the list of transactions, requires a first approval for future payment of the transaction;
the processor reconciles the approved transactions and the rejected transactions with the confirmed transactions;
the EFT payment transaction includes a transaction number, a transaction type, a template, a source of funds and a future time indicating an approval time for future payment of the transaction;
the second approval:
is received from a senior approver;
facilitates a change and/or confirmation of the transaction; and
ensures transaction accuracy, by providing, prior to execution of each transaction, a receiving-country-specific format that complies with a receiving country's country-specific formatting requirements;
the list of transactions is shown as a cascade of detailed-transaction-display windows on the touch-screen handheld device, wherein only the top window of the cascade of detailed-transaction-display windows is fully visible.

7. The media of claim 6, further comprising a server that compiles the list of confirmed transactions, wherein the server receives confirmation of completion for each transaction on the list of confirmed transactions.

8. The media of claim 6, further comprising, displaying, on the touch-screen handheld device, the summary display window showing a sorted list of transactions.

9. The media of claim 8, wherein the list of transactions is sorted according to each transaction's future time.

10. The media of claim 6, wherein the rejected display window of the touch-screen handheld device comprises a menu for selecting a reason for rejection from a list of reasons for rejection.

11. The media of claim 10, wherein the menu for selecting a reason for rejection is a fill-in space.

12. The media of claim 6, further comprising, displaying, on the touch-screen handheld device, at least one detailed description of a transaction selected from the list of transactions shown by the summary display window of the touch-screen handheld device.
